(19) United States
(12) Patent Application Publication
(10) Pub. No.: US 2008/0093297 A1
(43) Pub. Date: Apr. 24, 2008

(54) Filtration System

(76) Inventors: Kenneth William Gock, New South Wales (AU); David Rhett Butler, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/813,936

(22) PCT Filed: Jan. 13, 2006
(86) PCT No.: PCT/AU06/00039

§ 371 Date: Jul. 13, 2007

(30) Foreign Application Priority Data
Jan. 14, 2005 (AU) 2005900156

(51) Int. Cl. B01D 65/02; B01D 61/00; B01D 61/08; B01D 63/02

(52) U.S. Cl. 210/636; 210/321.6; 210/321.67; 210/321.68; 210/321.69; 210/637

(57) ABSTRACT

A method and apparatus for cleaning a permeable, hollow membrane (7) in an arrangement of the type wherein a pressure differential is applied across the wall of the permeable, hollow membrane (7) immersed in a liquid suspension, the liquid suspension being applied to the outer surface of the permeable hollow membrane to induce and sustain filtration through the membrane wall, the method of cleaning comprising the step of producing mechanical agitation between the membrane and the liquid suspension to dislodge at least some of the solids retained in or on the membrane. Application of the pressure differential by force of gravity applied to the liquid is also disclosed.

### TECHNICAL FIELD

The present invention relates to membrane filtration systems, and more particularly, to a simple, low cost filtration system which may be used in remote, underdeveloped regions of the world or in locations where normal infrastructure has been damaged or destroyed by a natural or man-made disaster.

### BACKGROUND OF THE INVENTION

In many areas of developing countries, clean drinking water is a scarcity. Also for the more remote regions electricity is not available. In such regions the use of expensive, energy intensive water filtration systems is impractical. Filtration systems employing porous membranes have been in use for many years, however, these systems require expensive equipment and complex pumping, valve and cleaning systems. The expense is usually justified where a large-scale system is employed servicing a large community.

In poorer developing countries and/or in remote locations where economies of scale are not possible and ready access to electricity is limited or non-existent, there is a need for a simple, low cost filtration system which can deliver high quality drinking water on a small or limited scale such as a single farm house or a small rural village.

### DISCLOSURE OF THE INVENTION

The present invention seeks to overcome or ameliorate at least one of the disadvantages of the prior art, or to provide a useful alternative.

According to one aspect, the present invention provides a method of cleaning a permeable, hollow membrane in an arrangement of the type wherein a pressure differential is applied across the wall of the permeable, hollow membrane immersed in a liquid suspension, said liquid suspension being applied to the outer surface of the permeable hollow membrane to induce and sustain filtration through the membrane wall wherein:
(a) some of the liquid suspension passes through the wall of the membrane to be drawn off as clarified liquid or permeate from the hollow membrane lumen, and
(b) at least some of the solids are retained on, or in, the hollow membrane or otherwise as suspended solids within the liquid surrounding the membranes,
   the method of cleaning comprising the steps of;
i) producing mechanical agitation between the membrane and the liquid suspension to dislodge at least some of the retained solids.

Preferably, the method includes removing, at least partially, liquid from the feed side of the membrane before and/or during the step of producing the mechanical agitation.

According to another aspect, the present invention provides a method of cleaning retained solids from the surface of the permeable hollow membrane used in a membrane filtration system including the step of producing mechanical agitation between the membrane and liquid in which the membrane is immersed to dislodge at least some of the retained solids.

For preference, the mechanical agitation is produced by moving the membrane relative to the liquid or vice versa. The liquid is typically held in a vessel which may be open or closed to atmosphere. In such arrangements, the agitation may be produced by moving the vessel and the liquid therein relative to the membrane/s or vice versa. Such movement includes inter alia, rotation, lateral movement along an axis of the vessel and/or rocking movement. The movement is preferably oscillatory.

The cleaning method may be supplemented by use of a liquid backwash and/or chemical cleaning of the membranes using appropriate cleaning agents.

According to another aspect of the present invention there is provided a method of treating a liquid suspension to remove particulate material using one or more permeable, hollow membranes, the method including:

(a) applying a pressure differential across the walls of the permeable, hollow membranes immersed in a liquid suspension, said liquid suspension being applied to the outer surface of the permeable hollow membranes to induce and sustain filtration through the membrane walls wherein:
(i) some of the liquid suspension passes through the walls of the membranes to be drawn off as clarified liquid or permeate from the hollow membrane lumens, and
(ii) at least some of the particulate material is retained on or in the hollow membranes or otherwise as suspended solids within the liquid surrounding the membranes;
   wherein the pressure differential is produced by withdrawing liquid under force of gravity from the fibre lumens.

In one form of this method, the liquid suspension may be contained in a closed vessel and the liquid suspension fed into the vessel under force of gravity such that pressure is applied on the feed side of the membranes by gravity feed of liquid into the vessel and/or suction is applied to the membrane lumens by gravity flow therefrom.

According to another aspect of the present invention there is provided a method of treating a liquid suspension to remove particulate material using one or more permeable, hollow membranes, the method including:

(a) applying a pressure differential across the walls of the permeable, hollow membranes immersed in a liquid suspension, said liquid suspension being applied to the outer surface of the permeable hollow membranes to induce and sustain filtration through the membrane walls wherein:
(i) some of the liquid suspension passes through the walls of the membranes to be drawn off as clarified liquid or permeate from the hollow membrane lumens, and
(ii) at least some of the particulate material is retained on or in the hollow membranes or otherwise as suspended solids within the liquid surrounding the membranes;
   wherein the liquid suspension is contained in an open vessel and the pressure differential is produced by siphoning liquid from the membrane lumens.

According to another aspect of the present invention there is provided a method of treating a liquid suspension to remove particulate material using one or more permeable, hollow membranes, the method including:

(a) applying a pressure differential across the walls of the permeable, hollow membranes immersed in a liquid suspension, said liquid suspension being applied to the outer surface of the permeable hollow membranes to induce and sustain filtration through the membrane walls wherein:
(i) some of the liquid suspension passes through the walls of the membranes to be drawn off as clarified liquid or permeate from the hollow membrane lumens, and
(ii) at least some of the particulate material is retained on or in the hollow membranes or otherwise as suspended solids within the liquid surrounding the membranes;
(b) suspending said filtration;
(c) producing mechanical agitation between the membranes and the liquid suspension to dislodge at least some of the retained particulate material;
(d) removing liquid containing dislodged particulate material;
(e) recommencing said filtration.

In one embodiment the method includes the step of removing, at least partially, liquid from the feed side of the membrane before and/or during the step of producing the mechanical agitation.

The invention includes, in other aspects, apparatus for performing the various methods described.

### BRIEF DESCRIPTION OF THE DRAWINGS

Preferred embodiments of the invention will now be described, by way of example only, with reference to the accompanying drawings in which:

FIG. 1 shows a simplified side sectional elevation view of one embodiment of a filtration module according to the invention;

FIG. 2 shows a simplified side sectional elevation view of a second embodiment of a filtration module according to the invention;

FIG. 3 shows a simplified side elevation of one arrangement for producing mechanical agitation of the filtration module;

FIG. 4 shows a simplified side elevation of another arrangement for producing mechanical agitation of the filtration module;

FIG. 5 shows a simplified side elevation of another arrangement for producing mechanical agitation of the filtration module;

FIG. 6 shows a simplified side elevation of another arrangement for producing mechanical agitation of the filtration module;

FIG. 7 shows a simplified side elevation of a further embodiment of the filtration module according to the invention;

FIG. 8 shows a graph of transmembrane pressure, permeability, flow rate and feed fouling index (FFI) measured over time in respect of a membrane module according to one embodiment of the invention.

### DESCRIPTION OF PREFERRED EMBODIMENTS

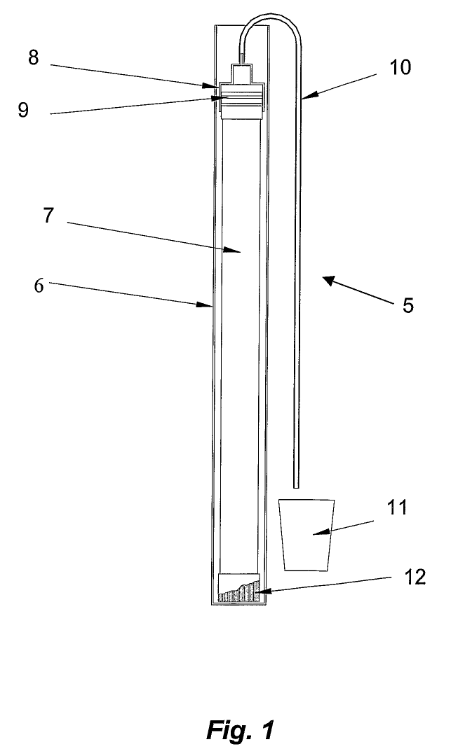

Referring to FIG. 1, the filtration device 5 comprises a open-ended tubular vessel 6 having a filtration module 7 fitted with a filtrate cup 8, sealed by O-rings 9 located therein. A hose 10 is connected at one end to the filtrate cup 8 and at its other end to an external container 11.

The filtration module is of the type described in our International Patent Application No. WO 98/28066, however, it will be appreciated that any suitable membrane filtration device may be used. In this module, however, no gas scouring is used and the openings within the lower pot are used for removing feed liquid from the module.

When operating in the filtration mode, a pressure differential is produced across the membrane by a siphoning action applied to the membrane lumens through the filtrate cup 8. Filtrate is drawn from the cup 8 and out through hose 10 into the external container 11 under atmospheric pressure. Additional suction pressure can be applied to the membrane by adding a suction device to the filtrate line. The advantage is that the differential pressure across the membrane is limited to the atmospheric pressure and hence excessive fouling of the membrane can be avoided.

The membrane at the bottom of the module is blocked off from the feed such that the filtrate and feed liquid remain physically separated. The openings (not shown) in the bottom pot 12 facilitate cleaning of the module 7.

Over time, the filtration flow rate reduces due to fouling of the membrane. Due to the low-pressure operation of the filtration process, the foulant formed on the filtrate side of the membrane is easily removed through mechanical agitation.

The mechanical agitation used for cleaning the membranes can take a number of forms which will be described later.

In the present embodiment, which uses an open vessel 6, agitation to the membrane is applied by plunging the membrane module 7 up and down inside the tubular vessel 6 and/or oscillating the module 7 about its longitudinal axis. To help remove solids from the inner membranes, holes in the lower pot 12 assist in providing agitation through hydraulic motion during the plunging operation.

Another form of agitation may be to apply gas pressure to produce bubbles to agitate the membrane through the holes in the lower pot 12. Alternatively, if the membrane module 7 is lying horizontally, then the gas can be applied along the length of the module.

After agitation, the tube vessel 6 is emptied of concentrated liquid containing the dislodged impurities and refilled. Emptying of the liquid may be done by pouring the liquid from the vessel 6, draining liquid through the base of the vessel, and/or pumping or siphoning liquid from the vessel. Depending on the feed liquid, it may require successive agitation, emptying and fill cycles to recover the filtration flow rate. On completion of cleaning the membrane module 7, filtrate cup 8 and hose 10 are primed with water to reinitiate filtration.

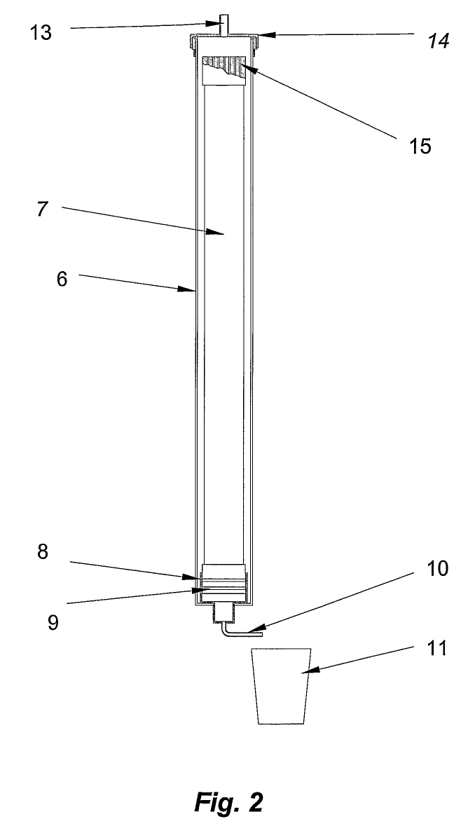

FIG. 2 shows an embodiment where the filtration module is inverted to that described in respect of the embodiment of FIG. 1. Feed liquid is fed to either an open or closed tubular vessel 6. In the embodiment illustrated, the tubular vessel 6 is closed with a feed connection 13 on the screwed end cap 14. For a closed vessel 6, the vessel 6 must be primed before sealing the end cap 14. Alternatively, the end cap can be sealed and a vent valve installed to allow venting during priming. Feed is pushed through the module 7 by a positive head pressure on the feed liquid. Additional pressure differential across the membrane can be applied through siphoning of the filtrate hose 10. The module 7 is located in a filtrate cup 8 which is sealed therein by O-rings 9. Clean filtrate exits the module 7 via the filtrate cup 8 through a hose 10 and is collected in a container 11. As in the configuration illustrated in FIG. 1, holes in the top end 15 of the module 7 assist in the cleaning operation.

The advantage of the closed vessel is that additional pressure using a header tank or any other pressure-boosting device can be placed across the membrane to provide a higher filtration flow.

Similar to embodiment of FIG. 1, cleaning is done by mechanical agitation of the membrane relative to the liquid within the module 7. The module 7 maybe removed from the tubular vessel 6 and cleaned or left within the vessel 6 and the entire assembly agitated to loosen the foulant. If the module is left mounted in the tubular vessel 6, then cleaning must be done with the vessel 6 at least partially filled with liquid. Where a closed vessel is used, the liquid within the vessel is desirably partially removed to allow the liquid to be agitated relative to the membranes.

After agitation the vessel 6 is again emptied of concentrated liquid containing dislodged impurities and refilled. Depending on the feed water, it may require successive agitation, drain and fill cycles to recover the filtration flowrate. It is advantageous to continue mechanical agitation during the emptying of the vessel 6. On completion of cleaning, the tubular vessel 6 and module 7 are primed with liquid to reinitiate filtration.

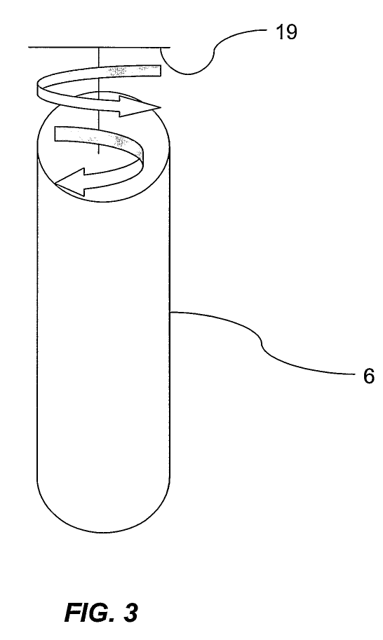

FIGS. 3 to 6 illustrate various embodiments of how the module may be mechanically agitated. It will be appreciated the methods illustrated are not exhaustive and a variety of mechanical agitation methods can be employed without departing from the scope of the invention described.

FIG. 3 shows a closed vessel 6 where the module 7 is agitated within the vessel by rotating the module 7 using an external t-shaped handle 19 connected to the module 7. The module 7 is normally rotated in an oscillatory fashion as illustrated. Alternatively, the vessel 6 can be rotated while the module 7 remains stationary or a combination of both motions in contra-directions can be used. Fins or the like (not shown) can be provided within the vessel 6 to assist agitation of the liquid therein. A similar action could be performed with the vessel 6 positioned horizontally or any desired angle of inclination.

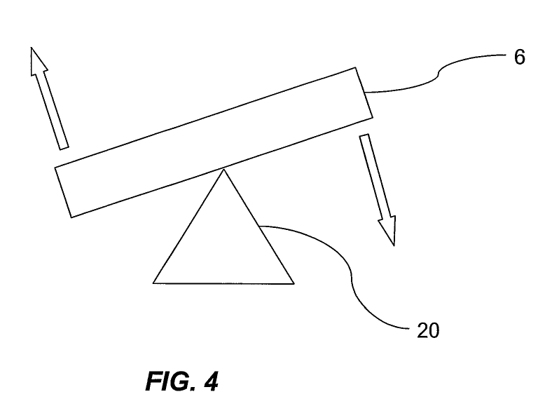

FIG. 4 shows an arrangement where the vessel 6 is mounted on a pivot 20 to allow the vessel 6 to be rocked to and fro about a central lateral axis.

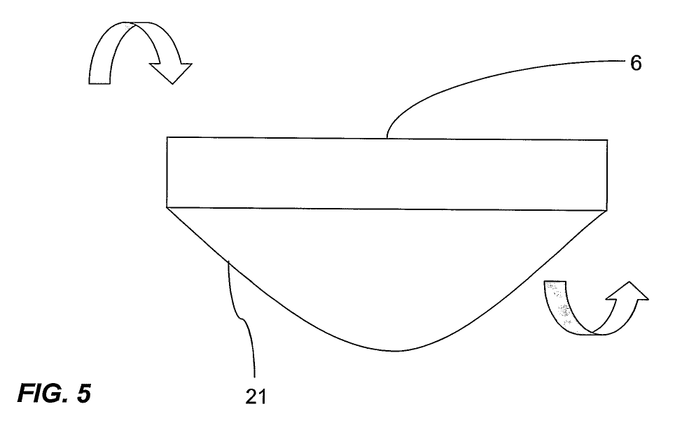

FIG. 5 shows a similar arrangement to FIG. 4 where the vessel 6 is mounted on a cradle 21 to allow the vessel 6 to be rocked to and fro about a central lateral axis.

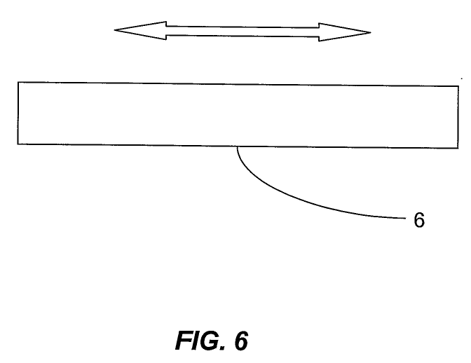

FIG. 6 shows an arrangement where the vessel 6 is placed in a horizontal position and oscillated to and fro along its longitudinal axis. A similar action could be performed with the vessel 6 positioned vertically or any desired angle of inclination.

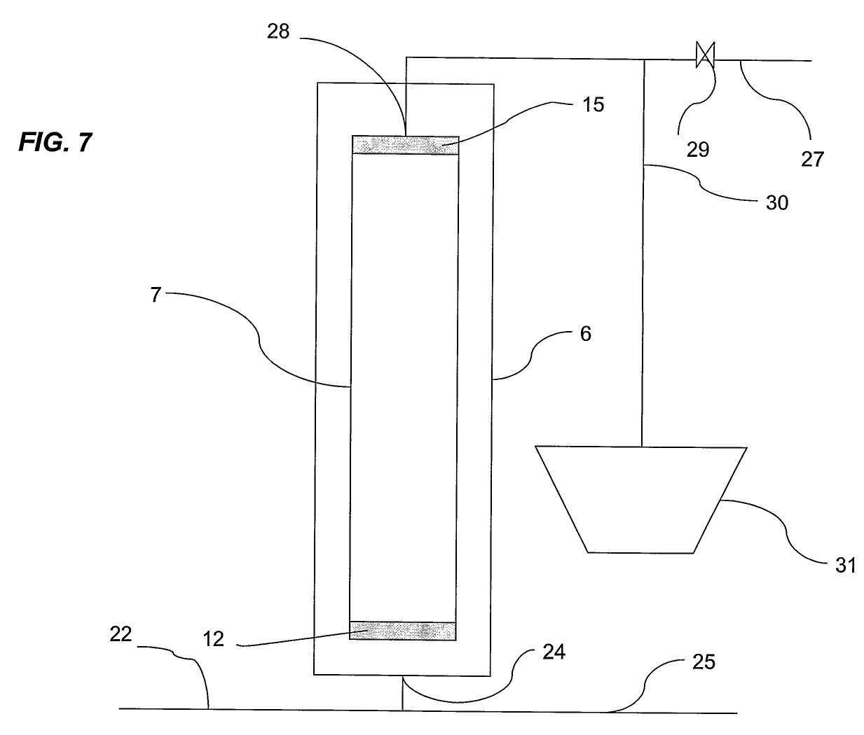

Referring to FIG. 7, one possible embodiment of the membrane module employing a liquid backwash is illustrated. It will be appreciated that a variety of backwash regimes could be employed with the invention described.

In FIG. 7, the module 7 is positioned in vessel 6 having an inlet feed line 22 controlled by a valve 23 connected to port 24. An outlet drain line 25 is also connected to port 24 and controlled by valve 26. The upper pot 15 is arranged to withdraw permeate from the membranes in the module 7 through output permeate line 27 connected to port 28 and controlled by valve 29. Backwash line 30 is also connected to port 28 and backwash container 31. A vent valve 32 is provided on the top of vessel 6 to vent air during filling and draining of the vessel.

In use, the arrangement operates in a similar manner to the embodiment illustrated in FIG. 1. Feed liquid is fed into the closed vessel 6 through feed line 22 and open valve 23. Valve 26 remains closed. Vent valve 32 remains open until the vessel is filled. Permeate is withdrawn under a siphoning effect through permeate line 27 and open valve 29. When a liquid backwash is required, valves 23 and 29 are closed and valves 26 and 32 opened. This results in liquid being drained from the vessel 6 through drain line 25 and backwash from container 31 being drawn back through the port 28 and the membrane lumens under atmospheric pressure. Apart from the usual liquid backwash using permeate, the arrangement may also be used to provide a chemical clean where appropriate level of chemical cleaning agents are provided from the container 31 which may be an open container or a bladder arrangement.

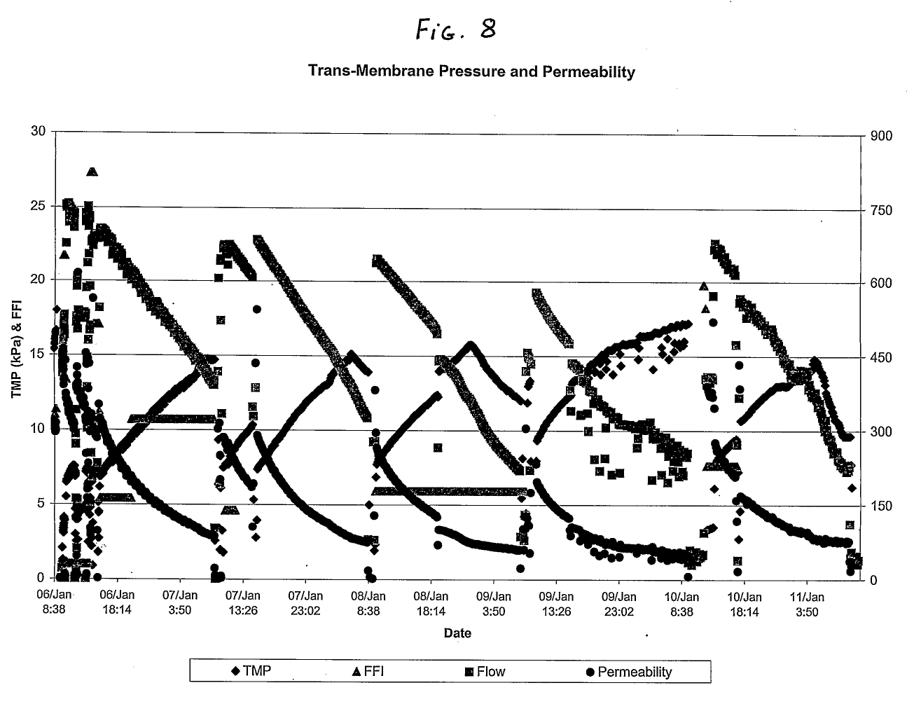

FIG. 8 shows a graph of changes in transmembrane pressure (TMP), filtrate flow, permeability and feed fouling index (FFI) over time. It illustrates the increase in TMP and reduction in permeability and filtrate flow rate with increased fouling of the membranes. Following mechanical agitation cleaning of the membranes, TMP is reduced and permeability and filtrate flow rate increased.

It will be apparent to those in the art that the mechanical agitation steps of the method can be performed manually and/or be automated by the addition of an appropriate form of mechanical drive.

It will be appreciated that further embodiments and exemplifications of the invention are possible without departing from the spirit or scope of the invention described.

1: A method of cleaning a permeable hollow membrane in an arrangement of the type wherein a pressure differential is applied across the wall of the permeable hollow membrane immersed in a liquid suspension, said liquid suspension being applied to the outer surface of the permeable hollow membrane to induce and sustain filtration through the membrane wall wherein:
(a) some of the liquid suspension passes through the wall of the membrane to be drawn off as clarified liquid or permeate from the hollow membrane lumen, and
(b) at least some of the solids are retained on or in the hollow membrane or otherwise as suspended solids within the liquid surrounding the membrane, the method of cleaning comprising the steps of:
(i) producing mechanical agitation between the membrane and the liquid suspension to dislodge at least some of the retained solids, and
wherein the method further includes removing, at least partially, liquid from the feed side of the membrane before and/or during the step of producing the mechanical agitation.

2: A method according to claim 1 wherein the mechanical agitation is produced by moving the membrane relative to the liquid suspension or vice versa.

3: A method according to claim 2 wherein the liquid suspension is held in a vessel and the agitation is produced by moving the vessel and the liquid suspension therein relative to the membrane or vice versa.

4: A method according to claim 2 wherein said movement includes one or more of the following types of movement: rotation, lateral movement along an axis of the vessel, rocking movement.

5: A method according to claim 4 wherein the movement is oscillatory.

6: A method according to claim 1 further including the step of a liquid backwash of the membrane.

7: A method according to claim 1 further including the step of a chemical cleaning of the membrane using a cleaning agent.

8: A method of cleaning retained solids from the surface of a permeable hollow membrane used in a membrane filtration system including comprising the step of producing mechanical agitation between the membrane and liquid in which the membrane is immersed to dislodge at least some of the retained solids.

9: A method according to claim 8 wherein the mechanical agitation is produced by moving the membrane relative to the liquid or vice versa.

10: A method according to claim 9 wherein the liquid is held in a vessel and the agitation is produced by moving the vessel and the liquid therein relative to the membrane or vice versa.

11: A method according to claim 9 wherein said movement includes one or more of the following types of movement: rotation, lateral movement along an axis of the vessel, rocking movement.

12: A method according to claim 11 wherein the movement is oscillatory.

13: A method according to claim 8 further including the step of a liquid backwash of the membrane.

14: A method according to claim 8 further including the step of a chemical cleaning of the membrane using a cleaning agent.

15: A method of treating a liquid suspension to remove particulate material using one or more permeable hollow membranes, the method comprising the steps of:
(a) applying a pressure differential across the walls of the permeable hollow membranes immersed in a liquid suspension, said liquid suspension being applied to the outer surface of the permeable hollow membranes to induce and sustain filtration through the membrane walls wherein:
(i) some of the liquid suspension passes through the walls of the membranes to be drawn off as clarified liquid or permeate from the hollow membrane lumens, and
(ii) at least some of the particulate material is retained on or in the hollow membranes or otherwise as suspended solids within the liquid surrounding the membranes;
wherein the pressure differential is produced by withdrawing liquid under force of gravity from the fibre lumens.

16: A method according to claim 15 wherein the liquid suspension is contained in a closed vessel and the liquid suspension is fed into the vessel under force of gravity such that pressure is applied on the feed side of the membranes by gravity feed of liquid into the vessel.

17: A method of treating a liquid suspension to remove particulate material using one or more permeable hollow membranes, the method comprising the steps of:
(a) applying a pressure differential across the walls of the permeable, hollow membranes immersed in a liquid suspension, said liquid suspension being applied to the outer surface of the permeable hollow membranes to induce and sustain filtration through the membrane walls wherein:
(i) some of the liquid suspension passes through the walls of the membranes to be drawn off as clarified liquid or permeate from the hollow membrane lumens, and
(ii) at least some of the particulate material is retained on or in the hollow membranes, or otherwise as suspended solids within the liquid surrounding the membranes;
wherein the liquid suspension is contained in an open vessel and the pressure differential is produced by siphoning liquid from the membrane lumens.

18: A method of treating a liquid suspension to remove particulate material using one or more permeable hollow membranes, the method comprising the steps of:
(a) applying a pressure differential across the walls of the permeable hollow membranes immersed in a liquid suspension, said liquid suspension being applied to the outer surface of the permeable hollow membranes to induce and sustain filtration through the membrane walls wherein:
(i) some of the liquid suspension passes through the walls of the membranes to be drawn off as clarified liquid or permeate from the hollow membrane lumens, and
(ii) at least some of the particulate material is retained on or in the hollow membranes, or otherwise as suspended solids within the liquid surrounding the membranes;
(b) suspending said filtration;
(c) producing mechanical agitation between the membranes and the liquid suspension to dislodge at least some of the retained particulate material;
(d) removing liquid containing dislodged particulate material;
(e) recommencing said filtration, and
wherein the method further includes the step of removing, at least partially, liquid from the feed side of the membrane before and/or during the step of producing the mechanical agitation.

19: A method according to claim 17 wherein the mechanical agitation is produced by moving the membrane relative to the liquid suspension or vice versa.

20: A method according to claim 19 wherein the liquid suspension is held in a vessel and the agitation is produced by moving the vessel and the liquid suspension therein relative to the membrane or vice versa.

21: A method according to claim 19 wherein said movement includes one or more of the following types of movement: rotation, lateral movement along an axis of the vessel, rocking movement.

22: A method according to claim 21 wherein the movement is oscillatory.

23: A method according to claim 17 further including the step of a liquid backwash of the membrane.

24: A method according to claim 17 further including the step of a chemical cleaning of the membrane using a cleaning agent.

25: A filtration system including a permeable hollow membrane in an arrangement of the type wherein a pressure differential is applied across the wall of the permeable hollow membrane immersed in a liquid suspension, said liquid suspension being applied to the outer surface of the permeable hollow membrane to induce and sustain filtration through the membrane wall comprising:
(a) some of the liquid suspension passes through the wall of the membrane to be drawn off as clarified liquid or permeate from the hollow membrane lumen, and
(b) at least some of the solids are retained on or in the hollow membrane or otherwise as suspended solids within the liquid surrounding the membrane,
wherein the system includes means for cleaning the membrane including means for producing mechanical agitation between the membrane and the liquid suspension to dislodge at least some of the retained solids.

26: A filtration system according to claim 25 wherein the mechanical agitation means includes means for moving the membrane relative to the liquid suspension or vice versa.

27: A filtration system according to claim 26 wherein the system includes a vessel for holding the liquid suspension and the agitation is produced by moving the vessel and the liquid therein relative to the membrane or vice versa.

28: A filtration system according to claim 26 wherein said movement includes one or more of the following types of movement: rotation, lateral movement along an axis of the vessel, rocking movement.

29: A filtration system according to claim 28 wherein the movement is oscillatory.

30: A filtration system according to claim 27 wherein the vessel and/or membrane are fixed about an axis and said movement is relative to said axis.

31: A membrane filtration system including one or more permeable, hollow membranes immersed in a liquid and means for cleaning from the surface of a permeable hollow membranes at least some of solids retained thereon during filtration, wherein said cleaning means includes means for producing mechanical agitation between the membrane and liquid in which the membranes are immersed to dislodge at least some of the retained solids.

32: A filtration system according to claim 31 wherein the mechanical agitation means includes means for moving the membrane relative to the liquid suspension or vice versa.

33: A filtration system according to claim 32 wherein the system includes a vessel for holding the liquid suspension and the agitation is produced by moving the vessel and the liquid therein relative to the membrane or vice versa.

34: A filtration system according to claim 32 wherein said movement includes one or more of the following types of movement: rotation, lateral movement along an axis of the vessel, rocking movement.

35: A filtration system according to claim 34 wherein the movement is oscillatory.

36: A filtration system according to claim 33 wherein the vessel and/or membrane are fixed about an axis and said movement is relative to said axis.

37: A filtration system according to claim 25 wherein said mechanical agitation means includes motor driven means.

38: Apparatus for treating a liquid suspension to remove particulate material therefrom using one or more permeable hollow membranes, the apparatus comprising:
(a) means for applying a pressure differential across the walls of the permeable hollow membranes immersed in a liquid suspension, said liquid suspension being applied to the outer surface of the permeable hollow membranes to induce and sustain filtration through the membrane walls wherein:
(i) some of the liquid suspension passes through the walls of the membranes to be drawn off as clarified liquid or permeate from the hollow membrane lumens, and
(ii) at least some of the particulate material is retained on or in the hollow membranes or otherwise as suspended solids within the liquid surrounding the membranes;
wherein the means for applying a pressure differential includes means for withdrawing liquid under force of gravity from the fibre lumens.

39: Apparatus according to claim 38 further including a closed vessel for containing the liquid suspension and means for feeding the liquid suspension into the vessel under force of gravity such that pressure is applied on the feed side of the membranes by gravity feed of liquid into the vessel.

40: Apparatus according to claim 38 further including means for producing mechanical agitation between the membranes and the liquid suspension to dislodge at least some of the retained particulate material.

41: Apparatus for treating a liquid suspension to remove particulate material therefrom using one or more permeable hollow membranes, the apparatus comprising:
(a) means for applying a pressure differential across the walls of the permeable, hollow membranes immersed in a liquid suspension contained in an open vessel, said liquid suspension being applied to the outer surface of the permeable hollow membranes to induce and sustain filtration through the membrane walls wherein:
(i) some of the liquid suspension passes through the walls of the membranes to be drawn off as clarified liquid or permeate from the hollow membrane lumens, and
(ii) at least some of the particulate material is retained on or in the hollow membranes, or otherwise as suspended solids within the liquid surrounding the membranes;
wherein the means for applying a pressure differential includes means for siphoning liquid from the membrane lumens.

42: Apparatus according to claim 41 further including means for producing mechanical agitation between the membranes and the liquid suspension to dislodge at least some of the retained particulate material.

43: A method of treating a liquid suspension to remove particulate material according to claim 16 further including the step of producing mechanical agitation between the membranes and the liquid suspension to dislodge at least some of the retained particulate material.

44-45. (canceled)
